(19) United States
(12) Patent Application Publication
(10) Pub. No.: US 2013/0262199 A1
(43) Pub. Date: Oct. 3, 2013

(54) CUSTOMIZABLE COMPUTER-ENABLED SYSTEM FOR IMPROVEMENT OF CONVERSION RATIOS IN CLIENT LEADS, CALL BROADCASTS, AD EFFICIENCY DETERMINATION, AND METHOD OF USE THEREOF

(71) Applicant: John Philip Murphy, Plainfield, IL (US)

(72) Inventor: John Philip Murphy, Plainfield, IL (US)

(73) Assignee: CALL POTENTIAL LLC, Crest Hill, IL (US)

(21) Appl. No.: 13/436,305

(22) Filed: Mar. 30, 2012

(51) Int. Cl. G06Q 30/02

(52) U.S. Cl. 705/14.4

(57) ABSTRACT

The present invention relates to a customizable computer-enabled system, software for the improvement of contact to sales conversion ratios of leads from incoming contacts in response to public advertisement, and methods of use therefor, and more specifically to a fully integrated customizable platform with an automated lead follow-up module, a module for the customization of lead cards and other service cards, a call broadcast interface, a customized evaluation system associated with the information processed by the other modules, and display dashboards for easy display to an administrator of return on investment data.

### FIELD OF THE INVENTION

The present invention relates to a customizable computer-enabled system and software for the improvement of contact to sales conversion ratios of leads from incoming contacts in response to public advertisement, and more specifically to a fully integrated customizable platform with an automated lead follow-up module, a module for the customization of lead cards and other service cards, a call broadcast interface, a customized evaluation system associated with the other modules, and display dashboards for easy display to an administrator of return on investment data.

### BACKGROUND

Modern digital technology allows for the creation of a wide range of new tools, methods and systems built to facilitate the broadcast of commercial advertising and other types of marketing to sell products or services. Over the last decades, the options offered to marketers for reaching potential customers have multiplied tenfold, but the efficiency and ultimately the return on investment of using these options are often difficult to quantify. Advertisers now sprinkle a fixed budget in any one of a large number of marketing tools available, such as for example television ads, press ads, online links, sponsoring of events and athletes, the print of banners on subways, etc. The choice of which venue to use to optimize marketing budgets is critical to the success of any corporation. The terms “ad” and “advertisement,” within this disclosure, can be used interchangeably.

Marketers prefer making informed choices on how best to allocate their limited resources and ultimately know which, if any, of the tools results in a lead and ultimately a sale. While the dollar spent in an advertisement campaign to sales is often too attenuated to conclude, advertisers agree that successful advertisements result in clients reaching out to inquire about a product or service; these are called “leads” as part of this specification. A lead in addition to any known definition is also defined as a potential customer action or contact who, but for the ad, would not have resulted in a contact. For example, if a printed advertisement is placed in a subway above a door, a lead can be defined as a subway rider or someone known to the subway rider dialing a phone number on the advertisement or surfing to the advertiser's website to enquire about the product. A lead within this context includes any conscious or subconscious decision by a potential client to contact the advertiser.

Services who offer advertisement spaces use metrics to help inform potential advertisers of the potential benefit of investing in any given advertisement. For example, the potential reach of a television advertisement is generally associated with viewership, but the constitution of the viewers can influence the generation of leads. A new car advertisement at the football game may generate multiple leads, while the same advertisement in a Saturday morning cartoon will not. Marketing is a multivariable field inherently very hard to predict. The need for metrics to help guide any investment of advertisement space is very important.

In recent times, a customer during the final stages of an online transaction is often asked where the lead generated (i.e., where the advertisement was seen). This type of information is helpful but often is only available once an advertisement campaign has been released.

Automated tools and software platforms have been created to help give advertisers information on the generation of leads. In U.S. Pat. No. 7,684,550 entitled Customer Information System shown at FIG. 1, the platform relies on the publication of distributed media advertisements with special service numbers (i.e., a different phone-in number for each advertisement). For example, an advertising campaign can be published in every car around a city, but each subway line will include an advertisement with a different phone number to be dialed. When a subway passenger calls in, simply by using the incoming phone number it is possible to generate information about the source of the lead (i.e., the advertisement used to generate the call). The same can be done online where different contact information, such as a different dynamic link, can be offered in each different advertisement campaign. An online advertiser will know all incoming leads from a specific IP server are associated with a specific advertisement campaign.

One of the main problems with this technology is its inherent complexity and the difficulty of adapting and modifying it. FIG. 1 shows how a computer network system must include a telephone server, a voice network, a public database, an electronic communication server, a system server, a blackbox server, and a user development device all in direct communication at the center of a client workstation. As a consequence of the bulkiness and complex interconnection of all these networks and systems, any given software interface used to run this system is lacking in flexibility and cannot be easily customizable by a user.

What is needed is a simplified customer information system capable of offering all of the functionalities of older generation devices in addition to enhanced functionalities while being highly customizable to help with the improvement of many of the metrics generated by this system. Also needed is a cost-efficient and easy-to-learn system for use by a large number of users and capable of adaptation as advertising campaigns evolve and change, staff rotates, and new system requirements are added.

In the system described at FIG. 1, calls and contacts are monitored and stored in a database. No system is described to follow up on calls that did not result in a commercial transaction. What is also needed is a system capable of call follow-up management and the customized system associated therewith, and a system for the immediate and ongoing evaluation of employees, users, locations, and any input parameter associated with the information processed by the system alone or in tandem with a reward/best practice board for publication of best practices to users.

### SUMMARY

The present invention relates to a customizable computer enabled system, software for the improvement of contact to sales conversion ratios of leads from incoming contacts in response to public advertisement, and methods of use therefor, and more specifically to a fully integrated customizable platform with an automated lead follow-up module, a module for the customization of lead cards and other service cards, a call broadcast interface, a customized evaluation system associated with the information processed by the other modules, and display dashboards for easy display to an administrator of return on investment data.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is an illustration from the prior art.

FIG. 2 is a simplified illustration of a computer according to an embodiment of the present disclosure.

FIG. 3 is a schematic representation of the hardware associated with a computer-enabled system for the improvement of conversion ratios from potential client leads to actual clients according to an embodiment of the present disclosure.

FIG. 4 is a schematic representation of the software interface of the computer-enabled system shown at FIG. 3 associated with initial phases of account activation by an account manager for a new location and the associated new target number according to an embodiment of the present disclosure.

FIG. 5 is a block diagram of the online interface for access to the software interface used on the computer-enabled system shown at FIG. 3 according to an embodiment of the present disclosure.

FIG. 6 is a diagrammatic representation in tree format of the root user menu and submenus offered to a user of the computer-enabled system shown at FIG. 3 according to an embodiment of the present disclosure.

FIG. 7 is a diagrammatic representation in tree format of the root menu offered to administrators of the computer-enabled system shown at FIG. 3 to customize the system according to an embodiment of the present disclosure.

FIG. 8 is a flow diagram representing the steps associated with the creation and population of a lead card associated with a lead and the follow-up method associated with the computer-enabled system shown at FIG. 3 according to an embodiment of the present disclosure.

FIG. 9 is a flow diagram representing the steps associated with the customization of grade sheets for evaluating the different users of the computer-enabled system shown at FIG. 3 according to an embodiment of the present disclosure.

FIG. 10 is a diagrammatic representation in tree format of the dashboard menu offered to administrators of the computer-enabled system shown at FIG. 3 according to an embodiment of the present disclosure.

FIG. 11 is a flow diagram representing the process of selection of different types of lead card for incoming contacts according to an embodiment of the present disclosure.

FIG. 12 is a diagrammatic representation in tree format of the call tracking root menu of the computer-enabled system shown at FIG. 3 according to an embodiment of the present disclosure.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

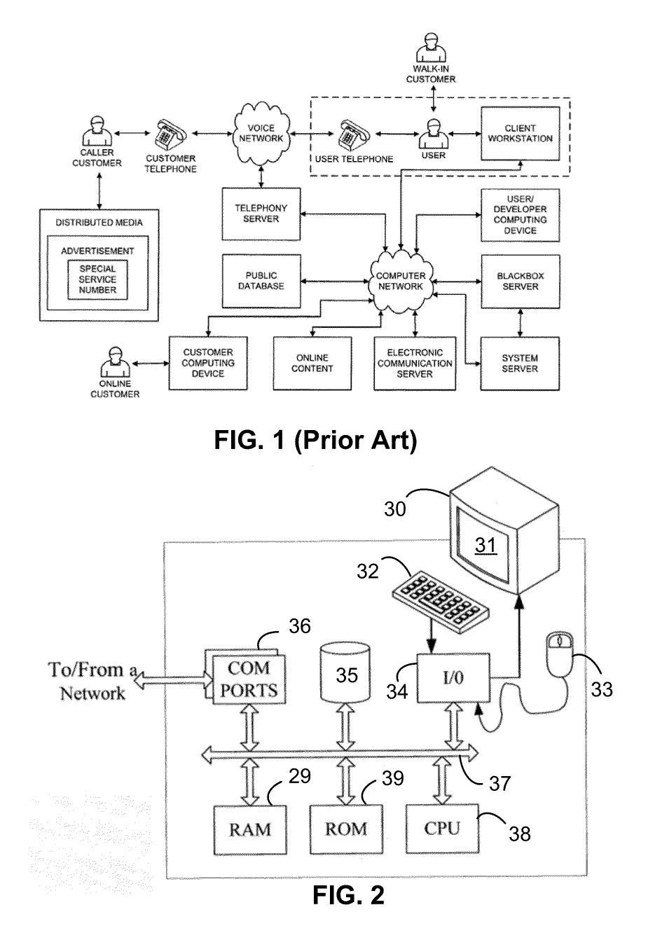

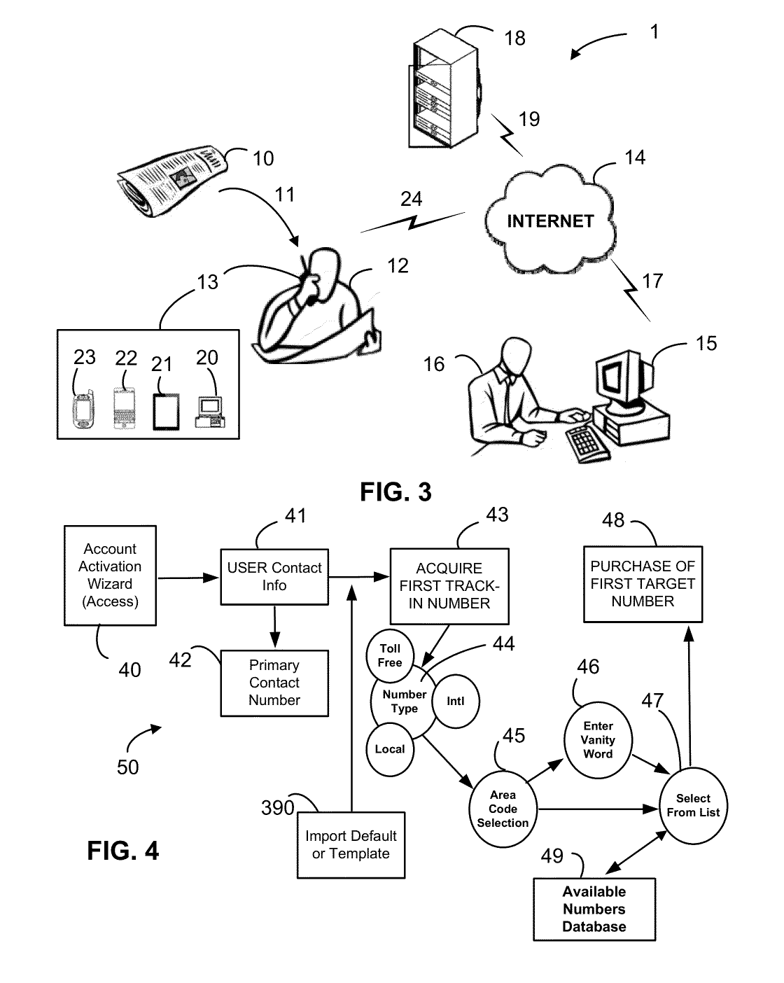

This disclosure relates generally to a software as shown in different block diagrams at FIGS. 4 to 12. The software can also be implemented as part of a platform or a system in hardware as illustrated at FIGS. 2 and 3. One of ordinary skill in software understands that the programming of software can be done using any one of a choice of programming languages or programming tools or programming packages found on the market. In today's world, computers are slowly migrating away from classical desk-based systems to more portable and compact units with integrated functions. While FIG. 2 shows a desktop computer operating with a remote web server, one of ordinary skill in the art will recognize that the functionality and features described by the system generally is applicable to any computer-enabled structure to transport information.

FIG. 2 teaches a computer 30 connected to a network using a communication port 36, such as a modem or other wireless port, in turn connected to a BUS 37 on a motherboard designed to connect the different elements of the computer 30. A random-access memory (RAM) 40 and a read-only memory (ROM) 39 are connected to the BUS 37 and are used by a computer processing unit (CPU) 38 for helping during the execution of computer software operating on a computer operating system or any other layer of software by the CPU 38. The computer 30 includes data 35 stored on memory or external memory also connected to the BUS 37 for exchange and access of information with the CPU 38 as it executes commands in the software from the ROM 39. Finally, a computer input/output (I/O) interface 34 is used to communicate between the CPU 38 and a user through different elements such as a keyboard 32 for the entry of commands, a mouse 33 also for the entry of commands, and a screen display 31 for viewing of the software and more recently for entry of commands in displays with touch technology. FIG. 2 shows generally one type of computer 30, but one of ordinary skill in the art of computer system will recognize the diverse variety of computers and computing systems currently on the market.

FIG. 3 shows the overall system and software platform 1 as working in the memory of a server 18 for sending information over a communication network 14 such as a local area network (LAN) or external networks like the Internet. Today with the arrival of cloud networking technology, the software platform 1 can be located physically on a single computer with a single web address (IP address) or be located in memory in a volume of data. The server 18 can be a web-enabled server with a computer interface such as a web-enabled server for connection to the Internet and exchange of information. In the illustration, server 18 is shown without a display or a terminal, but one of ordinary skill in the art will recognize that this hardware can take on many configurations.

Within this disclosure, the term “server” can mean both a hardware device with the features of the computer 30 used to store and service software, or a software interface used by a computer operating system to execute software and to transfer and manage data. As part of this disclosure, the term “server” is use as either a hardware equipped with software or simply a software interface. The term “software interface” or “software platform,” in addition to its ordinary definition and any definition understood by one of ordinary skill in the art, also broadly describes a software layer installed in computer memory for access by a user.

The software platform 1 shown at FIG. 3 also includes on the server 18 a database, a user interface, a processor for executing a user, follow-up software on the user interface, and a user communication device (UCD) such as a dial-in telephone server for receiving a plurality of communications from potential clients over the communication network. In one embodiment, these features are located directly on the server 18, and with the evolution of server technology, the server 18 operates either directly or through a user station 15 connected to the server 18 directly or through the Internet 17, 19, and is operated by a user 16 using the user interface. With evolving technology, one known way to execute a software interface or a software platform 1 is to place the executable code on an Internet-enabled server connected to an Internet portal or website at an HTTP address operating in HTML format.

The software platform 1 is generally advertised online as a multi-user software that can be used by multiple licensors from a single server. What is also contemplated is the sale of the software platform 1 as a stand-alone package or sold pre-installed on hardware devices. In a preferred embodiment, a website and users of the software platform are encouraged to use a locally installed browser like Internet Explorer® to connect to the HTTP site and sign in to the software using an access code and password. The software platform 1 is then executed using one of a variety of tools available to display executable code in a web browser, such as through generation of pages or running script capsules. The use of web-enabled browsers to access software platforms is well known and, while this use is described herein, what is also contemplated is the use of software executing on different platforms and computers like stand-alone computers and portable wireless devices. For example, a series of applications developed for wireless portable devices, for example in the APP format, can be used instead of or in conjunction with an HTTP site.

The software platform 1 generates tracking numbers through its telephone interface server (not shown) to be placed alongside a plurality of advertisements 10 each published or displayed in a plurality of public medias as shown at FIG. 3. While a newspaper is shown, what is disclosed is an advertisement with a tracking number located in any possible media, like posters, billboards, paper-based publications, television ads, online ads, search term ads, etc. In each case, the ad includes a different tracking number generated by the software platform.

In a print media, the tracking number can be a phone number generated by the software platform 1; in an online ad, the tracking number can be a phone number to call but can also be a dynamic link for connection via the Internet to the software platform. While two methods of communication are shown (spoken/written) between a potential customer 12 and the platform 1 and/or the user 16 of the platform, what is contemplated is any form of communication that can result in communication and ultimately the generation of a lead and a commercial transaction.

Also as part of this system, incoming calls or communications as shown by reference number 24 on FIG. 3 can be received and processed using many different devices or tools 13; for example, a potential customer 12 can use a cell phone 23, an iPhone® 22, a tablet 21, or a portable or desktop computer 20. In the case of a call, a caller ID a/k/a CID or calling line identification (CLID), calling number delivery (CND), calling number identification (CNID), or calling line identification presentation (CLIP) can allow for the system 1 to obtain information about the caller, such as the caller's number, and a name associated with the phone number. Other systems include an automatic number identification (ANI) or other software used to generate HTML pages that can replace any variable on a page by a selected number. For example, coding can be placed upfront in a page to modify an HTML page upon loading by a web browser of a potential client to replace a variable with a tracking number or a web link. What is contemplated is the use as a tracking number of any type of data, symbol, or sign that can be used to index a source of origin with a given advertisement 10.

As part of the platform and system 1, the tracking numbers are used by a plurality of potential clients 12 to contact a user 16 of the system or the system itself using a plurality of client communication device (CCDs) 13. The web server 18 also includes a database for indexing the tracking numbers in conjunction with each advertisement. The concept of tracking numbers in one embodiment includes the selection and use of area codes, phone numbers, international dial numbers, and toll-free numbers.

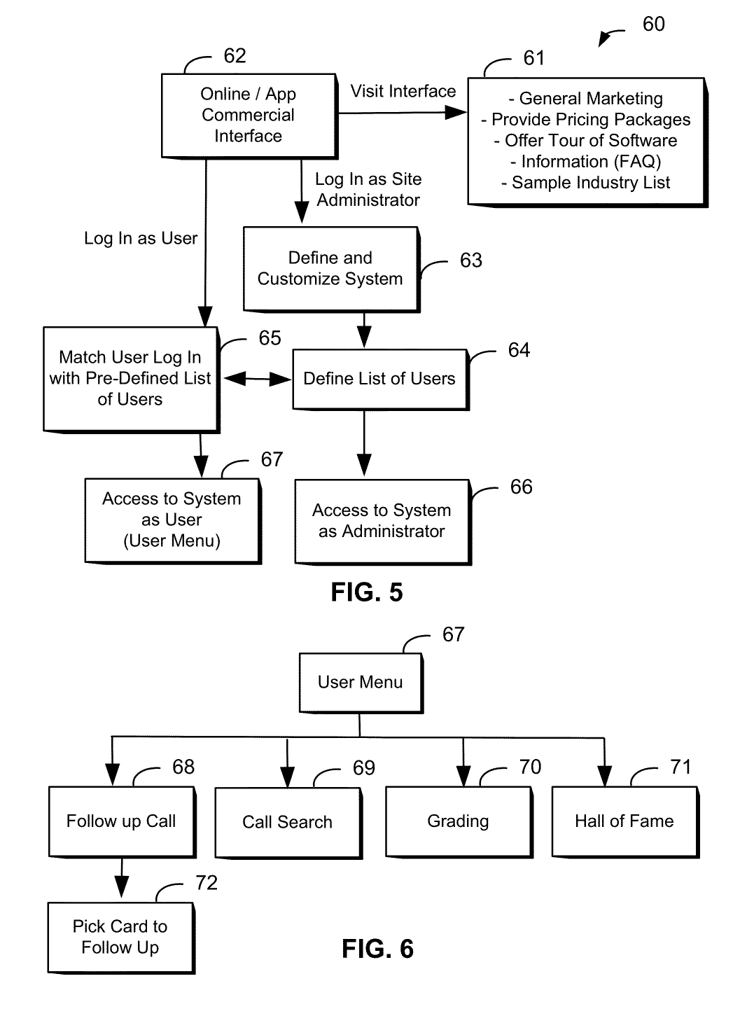

FIG. 5 is a block diagram of a first portion of the online interface 60 for access to the software interface used on the computer-enabled system shown at FIG. 3. An online interface 62 either on a web browser or a software running on a phone or a table call, an app or associated format offers three choices to any person arriving on the interface 60: a general information general marketing option 61 with information about the service offered by the interface 60, including for example pricing of the different packages; a virtual tour of the software along with a user guide, information; and responses to frequently asked questions; and client sample industry list.

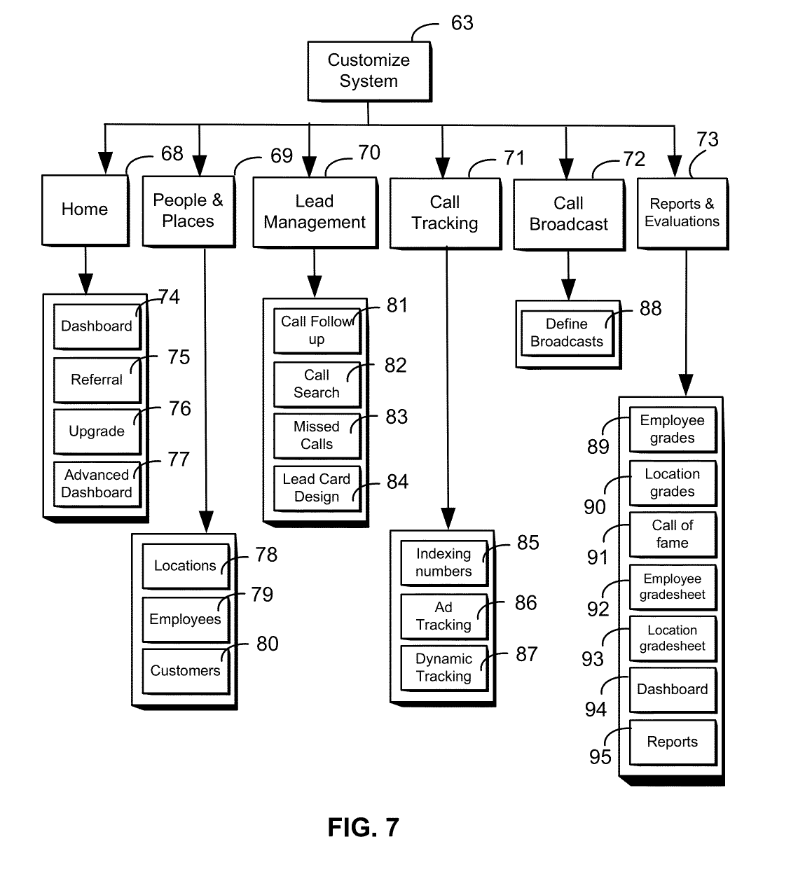

A site visitor (user 16 in FIG. 3) arriving at the interface 60 is then asked to either log in as a potential user (i.e., a person who processes calls and leads). Access will be granted based on a matching 65 of the user log-in and predefined user name with a database created by an administrator of the system 64 who in turn logged in as a site administrator and is given the capacity to define and customize the interface 60. Administrators are given access by the interface owner after a purchase of a commercial package and associated rights to set up the interface. A user who logs in to the system is given, for example, a user menu 67 shown with greater detail at FIG. 6. A user who logs in to the system as an administrator 66 may then initially be directed to a wizard as shown in FIG. 4 and is then given rights to customize and adapt the system as shown at FIG. 7 with greater detail.

Returning to FIG. 4, the illustration is of a schematic representation of the software interface 50 once the administrator is given access to the system 66 as shown at FIG. 5. The administrator is then asked to create a first location that will be associated with a primary phone number and a single marketing ad, and will also be assigned default templates for most of the functionalities offered by the general interface. The wizard 40 first asks the administrator (here a user) to enter contact information 41. Generally, the administrator will enter the address and location of a principal place of business where leads are to be processed. The user who is called hereafter an administrator must have been accepted as an administrator through a membership, or the payment of any other fee to get access to the system. The system then asks for a primary contact number 42, described also as a phone number associated with a first entered location.

The administrator is then asked to acquire 43 a first tracking number using either an international, toll-free, or local number base 44. Once the type is selected 44, a possible area code is selected 45 and in a subsequent step, the user selects the number itself from a list 47 of automatically generated numbers. To help administrators find optimized tracking numbers, each dial is associated with letters on a classical numerical phone. By using letters, a phone number can be dialed using letters, for example the word LOVE corresponds to dial-in numbers 5, 6, 8, and 3. This is called a “vanity” word and it can be entered 46 in the search engine to help generate available tracking numbers for better advertising. Once a number is determined, the administrator can purchase or select 48 a first tracking number to be associated with the primary contact number 42 or any other portion of the interface. This process allows for an easy transition into the interface by associating a single location and a single tracking number with one site. As part of the initial process of setting up new accounts as shown on FIG. 4, a series of default setups or predesigned packages 390 for specific industries are offered to the administrators of the system. These default or predesigned packages are helpful to reduce setup time, and provide system information, by way of example.

FIG. 6 is a diagrammatic representation in tree format of the root user menu and submenus offered to a user of the computer-enabled system shown at FIG. 3. By “user” of the system, what is contemplated is an employee, an agent, an officer, or any other person who works for the user of the software interface called an administrator who is tasked with using the system as it may be set up by the administrator to optimize ad revenues and to improve commercial transactions from leads generated through marketing.

When a user logs in 67 as shown in FIG. 5, he is given several choices (each as tabs in the interface). The first is a call follow-up list 68 where cards that represent leads that require further action and follow-up can be picked up 72 with a click of the mouse. To understand the follow-up list, the system works with lead cards associated with each new incoming client contact. Cards are managed, used, and closed for each lead resulting from marketing efforts. For example, if a potential customer called and asked if there was a red sweater available as part of the sale of a new sweater shown on an ad, he may have been told no, and such a comment will have been entered into the lead card. A user will have entered in the lead card a delay of follow-up, for example one week. The system then will list cards outstanding and the user can then call back the customer (i.e., follow up) and report if the sweater was ever found and, if so, which competitor had the product. In another embodiment, the module allows for the generation of an immediate communication, such as an email, and the entry of one or a number of delays associated with the follow-up, for example, a call on day 2, day 4, and/or day 6 after a call is received and a lead card is generated.

An offer for the sale of a different substitute product can be made by the user to the potential customer during the follow-up call. To encourage creative follow-up, a hall of frame tab 71 is created that lists some important and noteworthy follow-ups. This hall of frame 71 can include information like the name of the user who is responsible for the call, notes on the call, or other fields like a scoring system to encourage users to perform. Hall of frame 71 is primarily designed to offer users noteworthy customer calls, but can also be designed to list exemplary follow-up calls by users in response to customer calls.

FIG. 6 also shows a tab where calls can be indexed and searched 69 using any field or information available to the user. For example, search indexes can list last calls, longest calls, calls from a specific ad, or use notes or other ad-specific information to get to calls and lead cards of interest. For example, a user may remember a previous caller wanted a red-colored sweater. By indexing written notes that relate to the color, the user can find and review this previous call and follow up and find inspiration as to how better to follow up. Finally, a tab for grading 70 is used by users to get feedback on their performances as their work is reviewed by their peers, for example administrators. While a system with administrators, users, and customers is shown, one of ordinary skill in the art will understand that any layering can be contemplated.

FIG. 7 is a diagrammatic representation also in tree format of the root menu offered to administrators of the computer-enabled system shown at FIG. 3 to customize the system from the menu as shown at FIG. 5 for the benefit of users. The platform is highly customizable 63, and each tab corresponds to data entry into a database where an administrator can add scroll down buttons, labels, notes, and any other portion to help with the follow-up. For example, the platform can be designed to help with a marketing department in a university who places ads and receives alumni pledging calls. By using multiple tracking numbers, the user, in this case a university student helping with fund-raising, can know where the alumnus accessed the system and have some information to help guide the conversation. For example, if the ad was placed in a sport campus brochure, the student as he or she pulls up the lead card will see this indexed information and know the alumnus is on campus somewhere. Using phone ANI information, the name of the caller can be displayed if called from a land line. A university will, as described in FIG. 5, define as administrators the university representative in charge of the program. Each user can be assigned at 64 as a fundraising student.

To help give this invention a wide range of use, each portion must be fully customizable by the university representative. At FIG. 7, the administrator is given a choice between the home tab 68, a people & place tab 69, a lead management tab 70, a call tracking tab 71, a call broadcast tab 72 and a reports and evaluation tab 73. While a handful of tabs are listed, what is contemplated is the use of any number of tabs needed to help with the use of the interface. Each subtab function is listed below these six respective tabs.

The call broadcast tab 72 allows for administrators to type in, to call in a recording, to upload an audio file, or record messages that will be broadcasted 88 using the interface to potential customers. These calls are not unlike “robocalls” used by political parties during elections. The customized interface allows for an administrator to enter times when the broadcast is sent, the rapidity and frequency of callback, and even offer options for a listener who receives the call to reach an operator, dial in to get information, or a list of other possible functions associated with automated callback systems. List of contact numbers can be attached. The broadcast can also be made via the web, and can also include an automated ad tracking number or link for potential customer to call back.

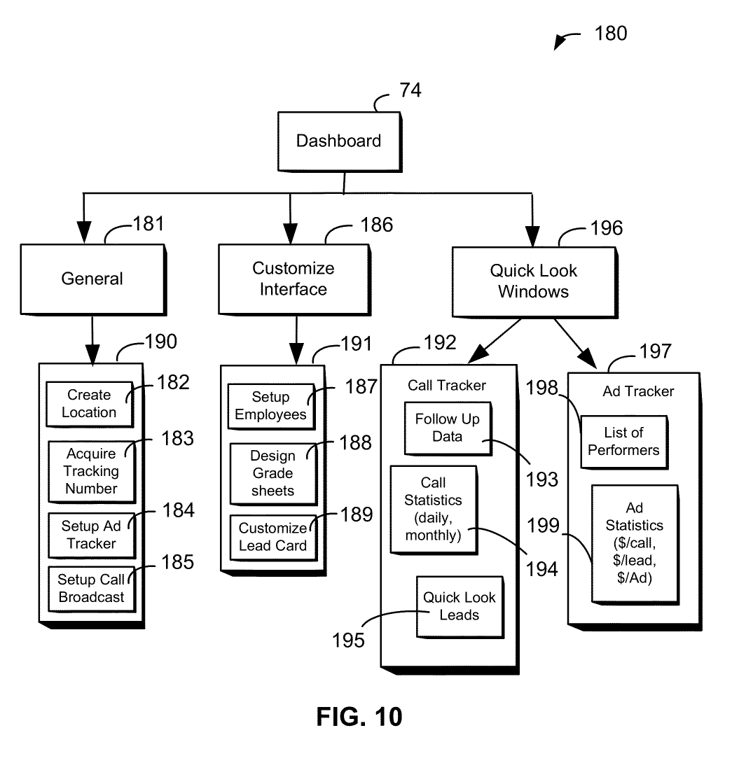

If the home tab 68 is selected, four suboptions are found, a dashboard 74 as described with greater detail at FIG. 10, a referral tool 75, an upgrade tool 76, and an advanced dashboard 77. The referral tab 75, for example, allows the entry of a list of contacts where marketing and publicity can be sent regarding the purchase of the software interface itself. The upgrade tab 76 allows an administrator to manage the services accessible under any given selected and paid plan. While a handful of possible payment options and plan options are given, what is contemplated is a tab for access of multiple plans leading for a change/upgrade of the potential of the platform. Described herein is a list of functions irrespective of their access by different versions of payment plans. One of ordinary skill in the art will recognize that some more “advanced” functions may not be available with basic or standard plans but will be made accessible, along with other services with the more complete packages.

People and places tab 69 allows an administrator to manage the different actors involved in the customized use of the platform by users. For example, the list of users defined at 64 in FIG. 5 can be listed as employees 79 to be entered or even customers 80 to be entered. For example, in the above example with the student hotline, employees 79 can be defined as the different counselors on staff, the location 78 the different call centers at the university, and the customers 80 the students in the student body. Because the employees are given access as users 65 as shown at FIG. 5, these are defined as users who will benefit from receiving solicitation from advertisements. In another embodiment, locations 78 are defined as different long-term storage centers owned by a corporation, the employees 79 the different managers of the locations 78 and the customers 80 are callers and current renters of storage areas. Each of these tabs and functions can be customized and new fields can be programmed for display to the user.

To manage a lead 70, the administrator is given several tools such as a call follow-up module 81 used to define the occurrence and need to follow up on any given call. The module includes lists of calls outstanding action and an association with the different employees, customers, and/or locations with each call. The administrator is able in this module to alter the call follow-up dynamics and change any parameter. For example, if because of a slowdown in work, the administrator desires to force follow-up on a weekly basis instead of a monthly basis, this can be set up. The follow-up information in one basic list includes the name and phone number to be called, the number of follow-ups, days past due for the follow-up, and an open and close label. In one other embodiment, the administrator can control the numbers to be called back, the use of an automated system, the frequency of automation and the capacity of the automation to hang up and redial if an automated system responds. The system can also include an automated message, and a dial in number to connect to a live operator/user if the person refuses the automated service.

The administrator is also able to customize 82 the call search feature 69 that is offered to users at FIG. 6. The administrator can include search functions, scroll down lists, etc. For example, a hotline may want to allow for search based on the type of call, the time of day or night, or the age of a student. What is contemplated is the use of a fully customizable database open for use by administrators alongside with a default option or other options offered by the owner of the software interface.

When calls or contacts come into the interface, users may not be available based on call volumes or the type of business models being helped by the interface. The administrator can create a useful interface for callers in case of missed calls. A lead card can be automatically generated or a message and options can be offered to the caller. If the system is over the Internet, guidance, links, and other fields can be offered. Finally, the last option on the lead management tab 70 is the capacity to design a lead card 84. The card can include prepopulated automatically generated information obtained dynamically when the client calls, and any other needed information. In this portion of the interface, administrators will regularly update fields as the different users interact with customers and generate cards. For example, as notes are written on each card by users, an administrator may decide to include a new field within the card to help collect information that otherwise must be inserted as part of notes.

The call tracking interface 71 allows for the creation of dynamic tracking tools 87 such as the capacity to automatically modify web pages and generate links. An ad tracking tool 86, where numbers are assigned to each ad, location, and information, can also be added along with a digital image of the advertisement. The indexing tool 85 allows the user to manage, select, and associate different numbers with advertisements. While basic functions are given, what is contemplated is the use of many more functions.

Administrators also are given a customizable tool to grade employees 89, grade locations 90, and even enter different elements into a call of frame 91 for the display by the user of the hall of frame 71 on their interface. Grade sheets for both locations 93 and employees 92 can also be customized at a different portion of the interface. To allow for grade sheets to be customizable over time while retaining information on previously graded sheets and allow for averages and grades to be relevant over time, the inventor has segmented the grade sheets into sections, each individually gradable. What is also contemplated is where the grade sheet is a grade sheet for grading calls and an off-line grade sheet for grading non-calls.

As part of the employee grade and location grading system 89, 90, the administrator can amend or add questions and/or sections to the grading. Questions and evaluation criteria can also be modified or added to questions or a section. For example, an initial grade sheet of an interface where the different locations are restaurants, the location grade sheet can include a first section on customer responsiveness, and a second section on the quality of the food. A year after the start of the system, the administrator can add a third section on the cleanliness of the restaurant. The grading interface designed 90 to give a 1-100% grade on each section, and an overall grade can now easily be amended to include a new section and keep the previous scores, for example at a certain time, the grade sheets have been in use for a while, and in this example Restaurant 1 has received 20 evaluations and Restaurant 2 only 15, each graded for sheets with two sections:

| | Section (Score) | |
|---|---|---|
| Location | [# evaluations] | Total (%) |
| Restaurant 1 | Responsiveness (85%) [20] | 82.5% |
| | Food Quality (80%) [20] | ({85 + 80}/2) |
| Restaurant 2 | Responsiveness (70%) [15] | 80% |
| | Food Quality (90%) [15] | ({70 + 90}/2) |

The administrator is then capable of adding a new section in the location grade sheet 93 and will manage the display of grades using module 90. This new section, for example, can be related to cleanliness. If module 90 asks that locations be graded weekly and three weeks are used, then the following evaluations would be produced:

| | Section (Score) | |
|---|---|---|
| Location | [# evaluations] | Total (%) |
| Restaurant 1 | Responsiveness (84%) [23] | 84.3% |
| | Food Quality (79%) [23] | ({84 + 79 + 90}/3) |
| | Cleanliness (90%) [3] | |
| Restaurant 2 | Responsiveness (70%) [18] | 76.7% |
| | Food Quality (90%) [18] | ({70 + 90 + 70}/3) |
| | Cleanliness (70%) [3] | |

In this example, grades are averaged per section and are not related to each individual weight (i.e., sampling) of the section. Once again, the customized system 63 offers sufficient flexibility to modify and set these parameters. One major advantage is to be able, on an ongoing basis, to keep all the previous grade sheets previously entered and continue with a modified grade sheet. At least a portion of the segments of some of the grade sheets are left blank because they were not filled in by an evaluator or because they were added to a subsequent version of the grade sheet through the customized interface of the grade sheet. What is also contemplated is the capacity of a user to enter self-evaluations of the different calls and associated lead cards or the entry of only portion of evaluations as part of grade sheets.

Finally, in the reports 95 section, a template can be created for the generation of regular reports that can be customized using any of the above information into any type of report.

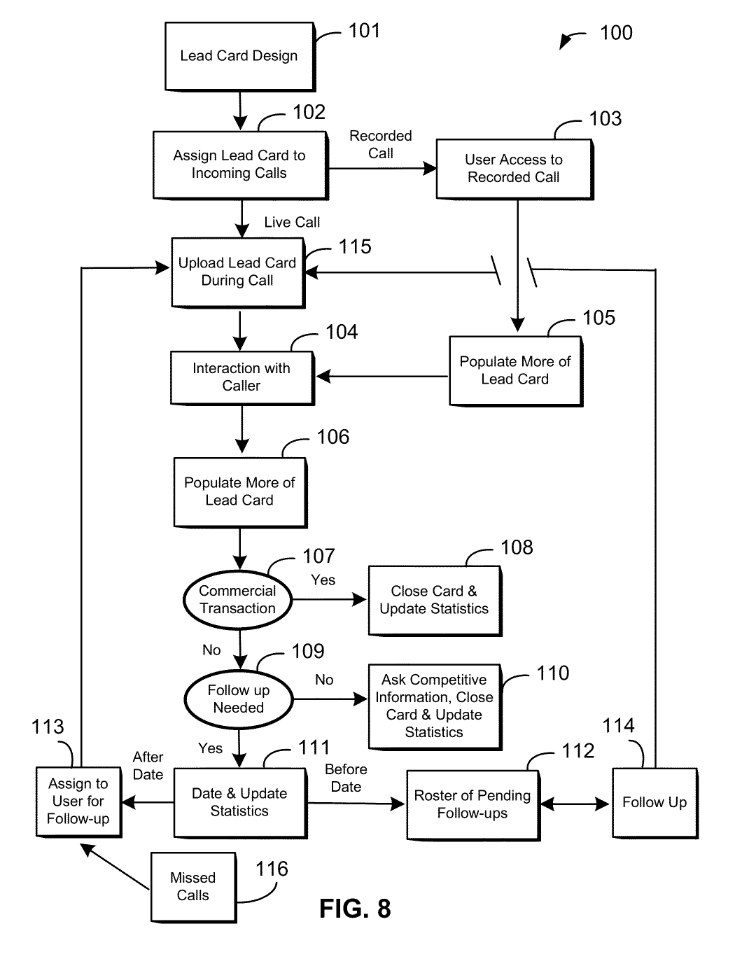

FIG. 8 is a flow diagram representing the steps associated with the creation and population of a lead card associated with a lead and the follow-up method associated with the computer-enabled system shown at FIG. 3. Using the customized system 63 shown at FIG. 7, an administrator can log into lead management 70 and design the lead card 84 as shown as a first step 101 of the process 100 at FIG. 8. As an incoming call arrives, it includes some automated source information and is directed to a certain tracking number. A lead card 102 is assigned to the call, and the information is extracted and stored in the lead card and populates at least a portion of the card as designed.

Either a live operator is present or the call is recorded 103 after a message is broadcast. The user can access 103 as shown at FIG. 6 the lead card 72 associated with the recorded call. Once the user listens to the message, he can populate some more fields of the card with the information 105 before he calls back to interact with the caller 104 as a step to follow up the call. Alternatively, if the call reaches a live operator, the card is automatically uploaded 115 before the interaction 104. In some cases, calls are “missed” for a plurality of reasons, such as when calls are dropped or callers hang up before cards are created. As shown at 116, missed calls can be assigned 113 to users for follow-up as part of the call follow-up process described at FIG. 6. During or after the call with the caller, the user is then capable of updating the card 106 by populating more fields. For example, if a commercial transaction occurs 107, then the card can be closed and sent to a graveyard where the administrator will update statistics and review the card, and the user who helped with the card, using an employee grade sheet. If no transaction occurred 109, either there is no longer a need for follow-up, in which case the user may ask more questions, for example, if the customer's need was satisfied by a competitive product or service 110, or there is any other need.

If the user determines there is a need for a follow-up, the need is dated 111 and the information is then sent to the data processing center. Once the date fixed by the user is met, the card is assigned 113 to a user for follow-up who in turn calls back the customer as shown in step 115 of FIG. 8. While there is no need to call back before the date set by the administrator, the information can be found in a roster of pending follow-up calls 112, and a user can always manually override the system 114 or be assigned cards differently, for example, by selecting the card and calling back the customer 115 as illustrated by the arrow on FIG. 8. As also shown at FIG. 8, in one embodiment, the customizable follow-up software comprises a module for allowing an administrator to set a follow-up schedule. This module can also include a delay to exclude certain calls from follow-up, for example more than X days into the future. The module can also limit follow up calls to a fixed number for the follow-up schedule to prevent overflow of information. Finally, the module can include the entry for the outcome of the follow up, for example in case of success, failure, the reason for a failure, the loss of the lead to a competitor.

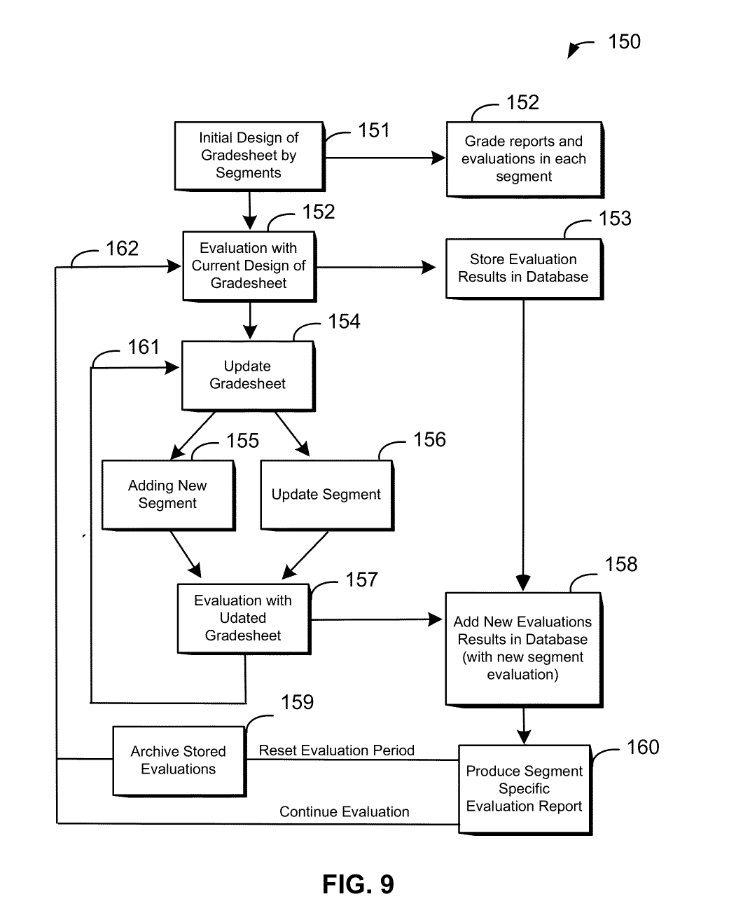

FIG. 9 is a flow diagram 150 representing the steps associated with the customization of grade sheets for evaluating the different users of the computer-enabled system shown at FIG. 3 as illustrated in the tables hereinabove. In an initial step 151, the initial design of the grade sheet (for a location, an employee, or any other grade sheet) is broken down into segments. As shown above, each segment is evaluated based on the need for the grade sheet and grade reports are produced 152 using the grading from the administrators or the users. Once evaluation starts with the current grade sheet 152, the data may be stored in a database 153 for evaluation and production of reports or the grade sheet can be updated 154 either by adding a segment 155 or by updating a segment 156. Subsequently, as shown in the second table above, evaluation of subsequent locations or employees can be made 157 using the updated grade sheet. The data can be added to the existing database as shown in the table 158. The upgrade of the grade sheet 161 can be made in subsequent steps each time needed.

In one contemplated embodiment, a report is produced that is segment-specific 160 and provide information detailed based on the individual questions and the individual sections. Evaluations using the updated grade sheet can be continued 162 or can be archived 159 at periodic evaluation intervals.

FIG. 10 a diagrammatic representation in tree format of the dashboard menu offered to administrators of the computer-enabled system shown at FIG. 3. The dashboard 74 as described herein is a quick reference guide and panel with condensed information and statistics useful for an administrator of the software interface. The dashboard 74 will include many of the above described functions in a single page to help an administrator have most of the information at a glance. Three main functions are given in the dashboard, a general tab 181 with several important useful functions like the call broadcast setup 185 also described at FIG. 7 as element 72, a setup of the ad tracker 184 also found at FIG. 7 as element 86, a tool to quickly acquire tracking numbers 183 also found at FIG. 7 as element 85, and finally a tool to create a new location 182 also shown as 78 at FIG. 7. These four tabs 190 can be used if a new creation is added to the list 182, and then new tracking numbers must be acquired 183, the numbers must then be set up in the system in association with ads 184, and finally the call broadcast can be set up 185.

In a second tab, the three most common customized tools listed as elements 79, 84, and 92 are offered 191 to include a means to set up employees 187, design grade sheets 188, and customize lead cards 189. While three useful tools are found as part of tab 94 on FIG. 7, the dashboard can be designed to include any one of the options described hereinbefore. Finally, the dashboard may include quick look windows 196 where some of the data collected from reports 95 can be displayed, for example, a call tracker window 192, and/or an ad tracker window 197.

Statistics of interest in this field can be the number of outstanding calls that require follow-up by the different users 193, statistics such as the number of calls received by the system or stored in the system 194, and a look at the number of leads generated by the interface 195. Also performance of employees, users, administrators, or even ads can be listed, for example, a top five ads generating the most leads 198 along with ad statistics such as cost per lead (i.e., the price of the ad divided by the number of leads generated from the tracking number associated with the ad), the cost per call (i.e., the price of the ad divided by the total number of calls generated by the leads) and the revenue per ad (i.e. the income generated or sales generated from a specific tracking number) 199.

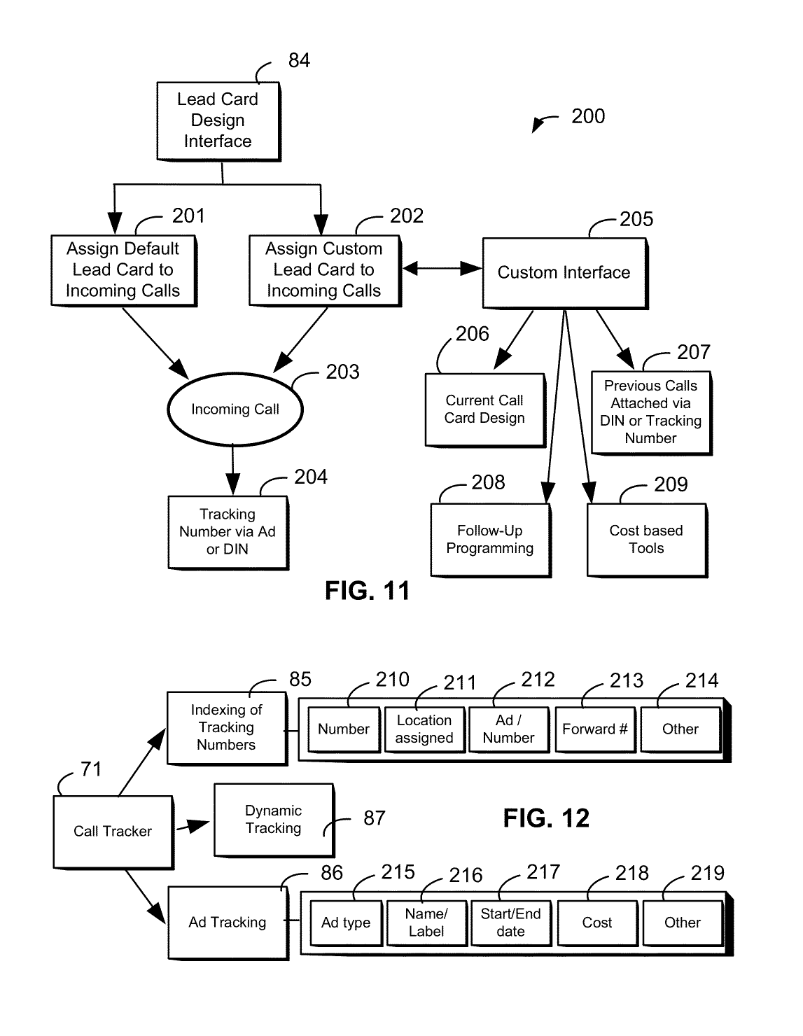

FIG. 11 is a flow diagram representing the process of selection 200 of different types of lead card for incoming contacts. As part of the lead card design interface 84, with every new call 203, a default lead card can be assigned to the call 201 or a custom lead card 202. Tracking can also be made automatically 204. The custom interface 205 to design the lead card can include current card design 206, previous calls attached 207, the different follow-up 208 or cost based tools 209. Finally, at FIG. 12 further detail for the elements 85 and 86 found on FIG. 7 is provided. The indexing of tracking numbers 85 can include a phone number 210, a location assigned 211, an ad number 212, a phone number for the forward 213 and other types of data 214. The ad tracking 86 includes an ad type 215, a name/label 216, a start and end date for the ad 217, the cost of the ad 218, and other information 219. for each user and each team, and ranking 206 each team in a post game report.

The follow-up software as illustrated in FIGS. 4-12 includes a lead card generation module 102 for assigning to each CCD incoming call 115 into the UCD a lead card template either the default lead card 201 or a custom lead card 202 as shown at FIG. 11, and populating each of the lead cards with at least the name of the customer, the tracking number received, and the advertisement associated with a location. The lead card management module allows the user of the software platform through the CCD to select one lead card 103 for interaction associated with one potential client, access the tracking number and the advertisement associated with the potential client 103, update the lead card of the potential client 105 and enter into an initial contact 104 with the potential client to enter into a commercial transaction 107, thus transforming the potential client into an actual client 108. The lead card follow-up module allows the user to enter a need for follow-up 109 in the lead card and assign for a later date a follow-up reminder 111 associated with the lead card. The lead card template includes at least one of a group consisting of a card closing tab, a competitive information tab, previous recordings from the tracking number, the CCD number or personal information, and previous recorded calls from the CDD number. The selection of lead cards can be done using as an indexing criterion a reason why a lost lead is not closed, or the name of a competitor.

In another embodiment, what is described is a customizable tool for the management of ad efficiency in a computer, with a user customizable ad efficiency software with a module for associating each contact from the plurality of potential clients to one of the plurality of advertisements, and a calculation module for calculating the cost per contact for each of the plurality of advertisement over time and ranking each ad on the user interface based on the cost per contact. The calculation module can also calculate the cost per lead for each of the plurality of advertisements over time and ranking each ad on the user interface based on the cost per lead and for the entry of revenue generated from each contact over time and ranking each ad based on the highest revenue generated.

In yet another embodiment, the system is directed to a customized call broadcasting computer-enabled system, with a customizable call broadcasting software with an input module for entry of a plurality of phone numbers where a broadcast must be sent, and a message generation module for recording generating the broadcast from a typed message. The system can also include a broadcast module having a cutoff switch to terminate the broadcast when an automated answering system responds to the broadcast, and wherein the broadcast module further includes a timed when-to-redial function.

Finally, what is also contemplated is a method for improving a conversion ratio of potential client leads answering a plurality of advertisements in a plurality of medias each with a different tracking number, the method including the steps of placing a plurality of advertisements in a plurality of public medias each with a different tracking number generated by a software platform, allowing a plurality of potential clients to contact a user of the software platform using a plurality of client communication devices (CCDs), indexing the tracking number of each incoming contact using the database to associate an advertisement from the plurality of advertisements to each tracking number, and creating and associating a customizable lead card for each of the incoming contacts. The method also may include the step of assigning a follow-up for each opened lead card until the lead card is closed.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

1. A computer-enabled system for the improvement of conversion ratios from potential client leads to actual clients, the system comprising:
a software platform on a server enabled for sending information over a communication network, the platform including a database, a user interface, a processor for executing user follow-up software on the user interface, and a user communication device (UCD) for receiving a plurality of communications from potential clients over the communication network; and
a plurality of advertisements in a plurality of public medias each with a different tracking number generated by the software platform, wherein the tracking numbers are used by a plurality of potential clients to contact the user using a plurality of client communication devices (CCDs), and wherein the tracking numbers are each associated with an advertisement in the database of the server,
wherein the follow-up software comprises:
a lead card generation module for assigning to each CCD incoming call into the UCD a lead card template and populating each of the lead cards with the name and the advertisement;
a lead card management module for allowing the user of the software platform through the CCD to select one lead card for interaction associated with one potential client, access the advertisement associated with the potential client, update the lead card of the potential client and enter into an initial contact with the potential client to enter into a commercial transaction, thus transforming the potential client into an actual client; and
a lead card follow-up module for allowing the user to enter a need for follow-up in the lead card and assigning for a later date a follow-up reminder associated with the lead card.

2. The system of claim 1, wherein the lead card follow-up module allows for the generation of an immediate follow-up communication and assigning of at least one later date for the follow-up reminder.

3. The system of claim 1, wherein the population of each lead card further includes the tracking number, and wherein the access by the lead card management module includes access to the tracking number.

4. The system of claim 3, wherein the lead card template is selected from a group consisting of a default template and a customized template, and wherein the customized template includes at least a feature entered by the user.

5. The system of claim 3, wherein the lead card template includes at least one of a group consisting of a card closing tab, a competitive information tab, previous recordings from the tracking number, the CCD number or personal information, and previous recorded calls from the CDD number.

6. The system of claim 3, wherein the software platform includes a user menu with a plurality of tabs for access of the follow-up software for the pickup of a lead card for follow-up, a search for calls, a grading system, and a hall of frame system.

7. A customized call follow-up computer-enabled system operating in a computer, the system comprising:
a software platform on a server enabled for sending information over a communication network, the platform including a database, a user interface, a processor for executing user-customizable follow-up software on the user interface, and a user communication device (UCD) for receiving a plurality of communications from potential clients over the communication network; and
a plurality of advertisements in a plurality of public medias each with a different tracking number generated by the software platform, wherein the tracking numbers are used by a plurality of potential clients to contact the user using a plurality of client communication devices (CCDs), and wherein the tracking numbers are each associated with an advertisement in the database of the server,
wherein the customizable follow-up software comprises an online commercial interface with a general information section, a user access log-in to a user menu, and a site administrator log-in to an administrator menu, where a site administrator assigns a plurality of users to a location, and
wherein the site administrator log-in menu includes an account activation wizard for setting up at least a first tracking number with user contact info at a first location and a primary contact number for the location, and an interface to customize a dashboard, a lead card, and a grade sheet.

8. The system of claim 7, wherein the grade sheet is a grade sheet for grading calls and the grade sheet is designed with a plurality of segments each for individual evaluation points.

9. The system of claim 6, wherein the grade sheet is an off-line grade sheet for grading non-calls.

10. The system of claim 8, wherein a report is produced based on the grade sheets for the employee for each segment and an overall evaluation is calculated.

11. The system of claim 8, wherein a period of evaluation for the employee is reset and any evaluation stored is archived.

12. The system of claim 8, wherein the customized dashboard includes at least a quick-look window and tabs to access general information or to customize the interface.

13. The system of claim 12, wherein the quick-look window is selected from a group consisting of a call tracker window, and an ad tracker window.

14. The system of claim 13, wherein the quick-look window further includes the display of useful statistics.

15. A customized call follow-up computer-enabled system operating in a computer, the system comprising:
a software platform on a server enabled for sending information over a communication network, the platform including a database, a user interface, a processor for executing user-customizable follow-up software on the user interface, and a user communication device (UCD) for receiving a plurality of communications from potential clients over the communication network; and
a plurality of advertisements in a plurality of public medias each with a different tracking number generated by the software platform, wherein the tracking numbers are used by a plurality of potential clients to contact the user using a plurality of client communication devices (CCDs), and wherein the tracking numbers are each associated with an advertisement in the database of the server,
wherein the customizable follow-up software comprises a module for allowing an administrator to set a follow-up schedule.

16. The system of claim 15, wherein the module further includes a delay to exclude certain calls from follow-up.

17. The system of claim 15, wherein the module include a fixed number of follow up calls for the follow-up schedule.

18. The system of claim 15, wherein the module includes an entry for the outcome of the follow-up.

19. The system of claim 15, wherein the module further includes the generation of an immediate follow-up communication and the assignment of at least one later date for the follow-up reminder.

20. A customizable tool for the management of ad efficiency in a computer, the tool comprising:
a software platform on a server enabled for sending information over a communication network, the platform including a database, a user interface, a processor for executing user-customizable ad efficiency software on the user interface, and a user communication device (UCD) for receiving a plurality of communications from potential clients over the communication network; and
a plurality of advertisements in a plurality of public medias each with a different tracking number generated by the software platform and each at a cost for placement, wherein the tracking numbers are used by a plurality of potential clients to contact the user using a plurality of client communication devices (CCDs), and wherein the tracking numbers are each associated with an advertisement in the database of the server,
wherein the customizable ad efficiency software comprises:
a module for associated each contact from the plurality of potential clients to one of the plurality of advertisements, and
a calculation module for calculating the cost per contact for each of the plurality of advertisements over time and ranking each ad on the user interface based on the cost per contact.

21. The tool of claim 20, wherein the calculation module further calculates the cost per lead for each of the plurality of advertisements over time and ranks each ad on the user interface based on the cost per lead.

22. The tool of claim 21, wherein the ad efficiency software also comprises a tool for the entry of revenue generated from each contact over time and ranking each ad based on the highest revenue generated.

23. A customized user evaluation computer-enabled system within a customized call follow-up computer enabled system, the system comprising:
a software platform on a server enabled for sending information over a communication network, the platform including a database, a user interface, a processor for executing user-customizable call broadcasting software on the user interface, and a user communication device (UCD) for receiving a plurality of communications from potential clients over the communication network; and
a plurality of advertisements in a plurality of public medias each with a different tracking number generated by the software platform, wherein the tracking numbers are used by a plurality of potential clients to contact the user using a plurality of client communication devices (CCDs), and wherein the tracking numbers are each associated with an advertisement in the database of the server,
wherein the customizable user evaluation system comprises:
an input module for entry of a plurality of evaluations of users using at least a grade sheet; and
a database for storing the plurality of evaluations of users.

24. The system of claim 23, wherein the grade sheet is customizable.

25. The system of claim 24, wherein the customizable grade sheet includes a plurality of segments.

26. The system of claim 23, wherein an evaluation report is produced from the database.

27. The system of claim 26, wherein the report includes segment-specific evaluations.

28. The system of claim 23, wherein the user evaluation system further comprises a self evaluation mode for entry of an evaluation by the user.

29. A method for improving a conversion ration of potential client leads answering a plurality of advertisements in a plurality of medias each with a different tracking number, the method comprising the steps of:
placing a plurality of advertisements in a plurality of public medias each with a different tracking number generated by a software platform on a server enabled for sending information over a communication network, the platform including a database, a user interface, a processor for executing user follow-up software on the user interface, and a user communication device (UCD) for receiving a plurality of communications from potential clients over the communication network;
allowing a plurality of potential clients to contact a user of the software platform using a plurality of client communication devices (CCDs);
indexing the tracking number of each incoming contacts using the database to associate an advertisement from of the plurality of advertisements to each tracking number; and
creating and associating a customizable lead card for each of the incoming contacts.

30. The method of claim 29, further comprising the step of assigning a follow-up for each opened lead card until the lead card is closed.

31. The method of claim 29, wherein the step of closing the lead card is a manual selection by the user on the customizable lead card.

32. The method of claim 29, further comprising the step of selecting lead cards using as an indexing criterion a reason why a lost lead is not closed.

33. The method of claim 30, further comprising the step of selecting lead cards using as an indexing criterion a name of a competitor.
